(19) United States
(12) Patent Application Publication
(10) Pub. No.: US 2023/0360150 A1
(43) Pub. Date: Nov. 9, 2023

(54) COMPUTER IMPLEMENTED METHOD FOR PROVIDING TEST DESIGN AND TEST INSTRUCTION DATA FOR COMPARATIVE TESTS ON YIELD, GROSS MARGIN, EFFICACY OR VEGETATION INDICES FOR AT LEAST TWO PRODUCTS OR DIFFERENT APPLICATION TIMINGS OF THE SAME PRODUCT

(71) Applicant: BASF AGRO TRADEMARKS GMBH, Ludwigshafen am Rhein (DE)

(72) Inventors: Hubert Schmeer, Langenfeld (DE); Christian Comberg, Köln (DE); Christian Bitter, Langenfeld (DE); Gauraw Kumar, Münster (DE); Ritika Kohli, Münster (DE); Richard Corden, Cheadle (GB); Jerome Casadebaig, Ecully Cedex (FR)

(21) Appl. No.: 17/786,446

(22) PCT Filed: Dec. 17, 2020
(86) PCT No.: PCT/EP2020/086726

§ 371 Date: Jun. 16, 2022

(30) Foreign Application Priority Data
Dec. 19, 2019 (EP) 19218234.3

(51) Int. Cl. G06Q 50/02; G06Q 10/0637; G06V 20/10

(52) U.S. Cl. CPC G06Q 50/02; G06Q 10/06375; G06V 20/188

(57) ABSTRACT

Computer implemented method for providing test design and test instruction data for comparative tests for yield and/or gross margin, efficacy and/or effects on certain vegetation indices on a field for at least a first product and a second product having a similar area of use.

### FIELD OF THE INVENTION

The present invention relates to a computer implemented method for providing test design and test instruction data for comparative tests for yield and/or gross margin, efficacy and/or effects on certain vegetation indices on a field for at least a first product and a second product, a use of field map data for such a method, a use of such a method for providing test result data, e.g. yield test result data, a system for providing test design and test instruction data for comparative tests for yield and/or gross margin, efficacy and/or effects on certain vegetation indices on a field on a field for at least a first product and a second product and a computer program element which when executed by a processor is configured to carry out such a method or alternatively to compare the effect of two different application times for the same product.

### BACKGROUND OF THE INVENTION

Agricultural management decision as timing, dosing and selection of planting date, crop protection measures, fertilizer application or harvesting operations are driven by environmental factors. In terms of timing and dosage, a farmer/agronomists usually rely on the information provided by manufacturers of agricultural products, e.g. seeds, growth promoters, fungicides, etc. However, these information are generalized statements which do not take into account the specific details of a particular field. Moreover, what is even more difficult for an agronomists is to choose the most suitable product from a variety of products intended for the same application/use. If an agronomist wishes to carry out his own field trials in order to derive adapt the generalized statements provided by the manufacturer or to choose one of the available products for a specific field, this is a comparatively cumbersome and lengthy task for him. It is difficult for an agronomist to choose the respective test parameters in such a way that he obtains reliable comparative yield tests results. In other words, it is difficult for an agronomist to plan comparative tests on yield, efficacy (e.g. weed or diseases control etc.) or various vegetation indices known by the agronomist (e.g. QCAB, fPAR, GLA, NDVI, NDRE, LAI, etc.) that allow him to determine causally which products, which product use rates and/or which application timings have an impact on the yield for a specific field.

In view of this, it is found that a further need exists to provide a method for providing test design and test instruction data for comparative tests on yield, efficacy (e.g. disease levels, crop height, green leaf area, plant counts, etc.) or various vegetation indices (e.g. NDVI, fPAR, etc.) in a field for two or more products and/or to compare the same product at two or more application timings.

### SUMMARY OF THE INVENTION

In the view of the above, it is an object of the present invention to provide a method for providing test design and test instruction data for comparative tests for yield and/or gross margin, efficacy and/or effects on certain vegetation indices on a field for different products.

These and other objects, which become apparent upon reading the following description, are solved by the subject matter of the independent claims. The dependent claims refer to preferred embodiments of the invention.

According to the invention, a computer implemented method for providing test design and test instruction data for comparative tests for yield and/or gross margin, efficacy and/or effects on certain vegetation indices on a field for at least a first product and a second product having a similar area of use is provided comprising the following steps:
providing field data comprising at least biomass distribution data and geographic data about the field on which the comparative tests are to be performed;
providing test data product use rate data about constant product use rates of said first product and said second product, and/or variable product use rates of said first product and said second products, and/or application timings of said first product and said second products whose effect, e.g. on yield, are to be compared by the comparative tests for yield and/or gross margin, efficacy and/or effects on certain vegetation indices;
generating test design data based on the provided geographic data by segmenting the field in plots and/or strips;
generating test instruction data by specifying at least two plots and/or at least two strips having comparable biomass data and assigning use rates and/or application timings of said products to the at least two plots and/or at least two strips having a comparable biomass data.

In other words, the present invention proposes to provide a test design based essentially on the biomass distribution of the field on which the comparative tests are to be carried out. This approach is based on the finding that the biomass distribution of a field represents an integrating indicator or the result of the different parameters of a field. This means that areas with similar biomasses typically have comparable field parameters/yield potential.

The product use rates of the two products may either be derived by the information of the manufacturer and/or are adjusted based on the biomass distribution data. Notably, the first and second product may also be the same product applied at different applications times, i.e. in this case the first product and the second product as such may be the same, but applied at different times.

Notably, the biomass distribution data is preferably provided by means of absolute (e.g. actual) LAI-biomass distribution data and/or multiyear LAI-biomass distribution data (i.e. LAI-biomass distribution data collected over several years; which can be either cross crop or crop specific representing the zonal differentiation of the yield potential (“power zones”)). However, any other vegetation based indices data may be or may additionally used in the present disclosure (e.g. Normalized Difference Vegetation Index (N DVI)). Moreover, the biomass distribution data may also be obtained by using Synthetic Aperture Radar (SAR), Light Detection and Ranging (LI DAR) derived sensor systems on various platforms as satellites, unmanned aerial or vehicles or ground vehicles. The absolute LAI-biomass data is preferably derived from satellite images and/or drone images, for example, provided in square meters of leaf area on a square meter of soil surface. Moreover, the absolute LAI-biomass data may also be based on remote sensing means and/or ground based sensing means arranged on a vehicle or sprayer, e.g. thereon mounted sensor means and/or camera systems. Preferably, the biomass data is based on current data obtained preferably within a time frame of one or two weeks prior to the start of the respective comparative tests and/or historical data obtained over a period of time, preferably over a period of more than or 10 years (i.e. multiyear LAI-biomass distribution data), showing the mid to long term productivity zones of a field across crop rotations. The biomass data preferably also comprises information in form of biomass zone categories, preferably indicating whether the biomass in a zone is above-average, average or below average, wherein it is preferred that the biomass data is provided in 3, 5 and/or 7 categories. Moreover, the term timing is to be understood in a broad manner and comprises at least two different meanings, namely that different application times and/or different application timings derived/controlled by using different “thresholds” in an on/off application mode of an applicator or sprayer (e.g. using different weed thresholds for a vehicle mounted threshold sensor which is controlling the on/off application or the flow rate of the applicator or sprayer).

One of the main aims of the present disclosure is to provide a tool to implement large scale, multiple site On-Farm-Development trials (OFD) to develop and optimize algorithms for variable rate or threshold based applications of all agricultural inputs as crop protection chemicals, seeds and fertilizers.

The term “field data” covers at least the biomass distribution and the geographical information, e.g. provided as so called shape file and field metadata, of the respective field. However, it is preferred that the “field data” further comprises electrical conductivity data, soil type data, soil texture data, topography data, organic matter data, nitrogen content data, potassium content data and/or pH value data and wherein when generating the test instruction data at least two plots and/or strips are specified having the comparable biomass data and electrical conductivity data, soil type data, soil texture data, topography data, organic matter data, nitrogen content data, potassium content data and/or pH value data; and/or when generating the test instruction data different data are weighted differently, preferably the biomass data is weighted with 50%, the electric conductivity data and topography data are weighted with 25% each. By considering topography differences, for example, it can be taken into account that more water may accumulate in concave terrain areas than in convex terrain areas. In this context, it should be noted that the present invention, apart from the biomass distribution data and the geographic data, is not limited to the incorporation of such further data; such incorporation is only preferred in order to further increase the causality/comparability of the test results of the comparative tests.

The term “test data” covers at least first product data about said first product, second product data about said second product, product use rate data about constant product use rates of said first product and said second product, and/or variable product use rates of said first product and said second products, and/or different application times (e.g. so called growth stage 31 or growth stage 39) of said first product and said second products whose effect, e.g. on yield, are to be compared by the comparative tests. It is further preferred that the “test data” further comprise repetition data comprising information about the intended treatment repetitions with said products and wherein when generating the test instruction data application time data corresponding to the treatment repetitions is assigned to the specified plots and/or strips.

Moreover, plot and/or a strip dimensions are preferably provided as basis for generating the test design data. Test data can, for example, be provided manually by an agronomist using corresponding input devices, such as the keyboard and mouse of a computer unit, and/or as a predefined standard test pattern. For example, the agronomist can be provided with a standard test pattern that he can adapt to his own needs. In this context, the agronomist can also be offered access to different databases from which he can select said products to be tested and from which he can take the standard use rates specified by the manufacturer. In this respect, it is further preferred that the method further comprises the step of generating the constant product use rates and/or variable product use rates based on the biomass distribution data. The use rates of the products to be compared can, for example, be adjusted as a function of the biomass distribution to be found in a field. This adjustment is based on the finding that for increasing the yield in a specific field, a higher product use rate should be used with higher biomass and a lower product use rate should be used with lower biomass.

The term “generating test design data” refers only to the segmentation of the field into “plots” and/or “strips”. In this context it should be noted that the segmentation of the field into plots and/or strips is automated or partially automated and does not depend on the biomass distribution, i.e. the determination of comparable plots and/or strips only takes place in a subsequent step when the plots and/or strips have been generated.

“Yield” is the harvested plant or crop biomass (e.g. indicated in tons or kilograms) per area unit (e.g. indicated in hectare or square meters) and per vegetation period (e.g. season), and yield is indicated for example as tons per hectare or kilograms per hectare. Notably, the term “yield” in the present disclosure can mean both, the so called “biological yield” and the so called “economic yield”. The “biological yield” is defined as “the total plant mass, including roots (biomass), produced per unit area and per growing season”. For the “economic yield”, “only those plant organs or constituents” are taken into account “around which the plant is grown”, wherein “a high biological yield is the basis for a high economic yield” (see Hans Mohr, Peter Schopfer, Lehrbuch der Pflanzenphysiologie, 3rd edition, Berlin/Heidelberg 1978, p. 560-561).

The term “product” is understood to be any object or material useful for the treatment. In the context of the present invention, the term “product” includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibi-tor, nitrification inhibitor, denitrification inhibitor, or any combination thereof; —biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof; —fertilizer and nutrient; —seed and seedling; —water; and —any combination thereof. In the context of the present invention, the term “product” also includes a combination of different products.

“Effects on certain vegetation indices” encompasses in particular a comparison of a vegetation index before and after a treatment. For example, in a first year the LAI (Leaf Area Index) of the respective area/field can be determined and compared with an LAI of the area/field in a second year. The skilled person knows a plurality of such vegetation indices that might be of interest. Not conclusive can be mentioned here for example: DVI (Difference Vegetation Index), RVI (Ratio Vegetation Index), NDVI (Normalized Differenced Vegetation Index), EVI (Enhanced Vegetation Index), GRABS (GReeness Above Bare Soil), etc.

The term efficacy can be understood as an equation in which the positive effects of the treatment in performing the desired plant protection activity (e.g. controlling the target pest or modifying crop growth) and any other useful effect, such as controlling other non-target pests, are balanced against the negative effects, such as direct damage to the crop (phytotoxicity) or effects on pollinators and natural enemies, or development of resistance.

A gross margin may be determined by deducting the direct costs of growing a crop from the gross income for a crop. Direct costs typically include those associated with crop production operations, harvesting and marketing. Gross margins do not include overhead costs such as rates, living costs, insurance, that must be met regardless of whether or not a crop is grown. For this reason gross margins are nota measure of the profit of a particular enterprise. However, for an agronomic gross margins provide a useful tool in terms of farm budgeting and estimating the likely returns or losses of a particular crop. Gross margins allow a skilled person to compare the relative profitability of alternative cropping options that have similar land, machinery and equipment requirements.

By means of the present invention, a farmer or agronomist may choose between a plot and/or a strip design. A strip design can be more easily implemented by farmers even without too sophisticated equipment, wherein a plot design make better use of the given field area and multiple different plots may be provided having comparable biomass values.

In the following, an example for providing/calculating a strip or plot design is explained. The spatial container, i.e. the field boundary, is provided by means of the field data. Subsequently, a tramline entry point and a tramline degree is chosen, usually based on the longest natural axis of the field, i.e. the tramline direction. Then, a strip design/pattern can be placed over the field based on the tramline entry point and the tramline direction, wherein the strip width is either preset or entered manually by a farmer as part of the test data. For the plot design, the strips are further divided, usually in regular plots. The tramline entry point is a point within the field, where the tramline (working line, driving lane) of the field equipment is identify. This should coincide with the center of the application machinery, such as the center of gravity point of an agricultural machine, e.g. a seeder, sprayer, etc. Notably, whether or not this marks the top, center or bottom in driving direction is not immensely important, since the full-field is traced out. The tramline enter degree is the driving orientation of the agricultural machine through the field. In practice, this typically coincides with the longest natural straight direction within the field. However, for fields that are more irregularly shaped, multiple such directions may exist. In such a case, it is preferred that the fields is split into multiple virtual fields, as single tramlines are easier to handle. Notably, this provided strip or plot design can be reused and the exact same positions can be used at different application times. Alternatively or in addition, permanent or temporary, so called geo-referenced AB-lines maybe used, if available to align the trial plots/stripes instead of using the above-described method.

Notably, for generating the test design data, it is also possible to use a machine-learning algorithm comprising an image recognition algorithm in particular for determining the tramline entry points, the tramline degrees and for providing the plots and/or strips. The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

The term “generating test instruction data” refers to the allocation of the respective application quantity/timings to “plots” and/or “strips” with a comparable biomass value, i.e. assigning said first product and said second product, use rates and/or application timings to these at least two plots and/or at least two strips. In this context, it should be noted that comparable biomass values are not limited to identical biomass values, as such an identity of biomass values will be comparatively rare in practice. The term comparable biomass values therefore refers to biomass values for which it is not to be expected that their difference will lead to a noticeable change in the test results, i.e. comparable biomass values are present if more or less identical results can be expected on two plots and/or strips under identical handling. As a result, the present invention provides a method for providing test designs and test instruction data for comparative tests for yield and/or gross margin, efficacy and/or effects on certain vegetation indices on a field for at least two products, wherein the tests may be performed using identical or different product use rates and/or the same or different timings, wherein the product use rates and/or the timings may also be adjusted to the respective (absolute) LAI-biomass value of the plots and/or strips which comprise the comparable biomass values.

Preferably, the method further comprises the steps of providing a product database in which at least information about products having a similar area of use are included; performing a database search in the product database determining a first product and a second product based on information about the area of use and/or determining a second product having a similar area of use in view of a specified first product; and providing first product data and second product data as test data. By providing such a product database, it is possible for an agronomist or by a computer based algorithm to identify products which are recommended by the manufacturer for a similar or identical use and which should/can be compared by the comparative tests to be carried out on the field. In this respect, it is further preferred that the product database also comprises information about use rates of the products provided by the manufacturer; and that a database search in the product database is performed determining a product use rate of said first product and/or a product use rate of said second product; and that product use rate data for said first product and/or product use rate data for said second product is provided; and that these use rate data are provided as test data. Notably, these product use rates proposed by the manufacturer may already be used for the comparative test or may be adjusted in view of the biomass data/values in the plots/strips.

Preferably, the test instruction data is generated by specifying different groups of plots and/or different groups of strips having comparable biomass data and assigning different product use rates and/or application timing to these groups of plots and/or groups of strips. In this context, it is preferred that the whole area of the field is assigned to a plot or a strip (fully randomized plot design). However, this invention is not limited to such an embodiment, i.e. it is possible that only parts of the field are assigned to a plot or strip (partially randomized plot design).

It is further preferred that the product is a seed product, a fertilizers product and/or a crop protection product. Preferably, however, a product according to the present disclosure is not the plant itself, but a product whose effects on the plant are to be investigated.

Notably, also for generating the test instruction data, it is possible to use a machine-learning algorithm, in particular for determining which plots and/or strips are comparable with respect to the biomass value. In particular, in case further parameters (e.g. electrical conductivity data, soil type data, soil texture data, topography data, organic matter data, nitrogen content data, potassium content data and/or pH value data) should also be considered when determining comparable plots and/or strips. In an example, in a first step, various data layers with respect to a parameters of the field may be generated/provided (e.g. a data layer for the soil texture of the field, a data layer for electrical conductivity of the field, a data layer for the topography of the field, etc. may be generated/provided). It is possible to use only some of these data layers, i.e. different data layers of the generated/provided data layers which appear to be decisive for a particular field may be “selected” and combined with the biomass data. Moreover, the different data layers may be weighted differently, e.g. the biomass data is weighted with 50%, the electric conductivity data layer and topography data layer are weighted with 25% each.

It is preferred that the method further comprises the step of generating sampling instruction data comprising information about sampling locations and/or sampling periods for taking samples or performing measurements in a respective plot and/or strip, wherein the locations are preferably provided in form of geographic coordinates. These sampling locations may be synchronized to the field trials officers mobile data loggers (e.g. laptops, smartphones, handhelds, etc.) together with the trial identity, crops etc. allowing to run a global trials network with a on-line, geo-referenced data and image collection.

In this respect, it is further preferred that the sampling locations are automatically placed away from the border of adjacent plots/strips and from tractor tramlines to avoid bordering effects. Moreover, in this respect, it is further preferred that the sampling locations are generated distanced from the border of adjacent plots/strips and from tractor tramlines, wherein the distance is between 2.5% and 20% of the plot/strip width and/or length, preferably 5% of the plot/strip width and/or length.

In other words, a sampling location should not be located on the outer area of a plot or strip. This is to avoid carry-over effects from nearby field areas, e.g. which has been treated differently, due to precision limits and potential errors. A point should also not be located on the center or center line of a plot or strip, which is potentially the area marked by a tractor, or any other piece of equipment, when moving in the middle of the observational unit to apply the particular treatment.

The method preferably further comprises the step of calculating tank mix data and/or seed amount or fertilizer amount based on the generated test instruction data and the geographic data. The aim of the tank mix calculation is to achieve a tank filling with which no or almost no tank mix remains in the tank after application, since such a remaining mix has to be diluted and destroyed by the farmer.

The present invention also relates to a use of field data comprising at least biomass data in a method for providing test design and test instruction data for comparative tests for yield and/or gross margin, efficacy and/or effects on certain vegetation indices on a field for at least two products as explained above, wherein based on the biomass data test instruction data is generated. Moreover, the present invention relates to a use of a method for providing test design and test instruction data for comparative tests for yield and/or gross margin, efficacy and/or effects on certain vegetation indices on a field for at least two products as explained above for performing a comparative test for yield and/or gross margin, efficacy and/or effects on certain vegetation indices on a field and for providing comparative test result data, e.g. yield test result data. In this respect it is preferred that the comparative test result data is used in a plant growth simulation and/or in a disease simulation model. Moreover, in this respect, it is further preferred that the comparative test result data is used for calculating product use rate data for “Variable Rate Applications” (VRA), “Variable Rate Seeding” (VRS), and/or “Variable Rate Fertilization” (VRF) and/or Multiple Rate Variation (MRV). Notably, the term use in a method has to be understood in that these data are used for performing/conducting/carrying out said method, i.e. in form of input data used for such a method.

The present invention also relates to a system for providing test design and test instruction data for comparative tests for yield and/or gross margin, efficacy and/or effects on certain vegetation indices on a field for at least a first product and a second product, comprising:
at least one data input interface configured to receive field data comprising at least biomass data and geographic data about the field on which the comparative tests are to be performed;
at least one data input interface configured to receive/capture test data comprising first product data about said first product, second product data about said second product, product use rate data about constant product use rates of said first product and said second product, and/or variable product use rates of said first product and said second products, and/or application timings of said first product and said second products whose effect (e.g. on yield) are to be compared by the comparative tests;
at least one processing unit configured to generate test design data based on the provided geographic data by segmenting the field in plots and/or strips;
at least one processing unit configured to generate test instruction data by specifying at least two plots and/or at least two strips having comparable biomass data and assigning use rates and/or application timings of said products to the at least two plots and/or at least two strips having a comparable biomass data.

Finally, the present invention relates to a computer program element, e.g. a Trial Planning App, which when executed by a processor is configured to carry out the above explained method. By means of such a computer program element, test designs and test instructions can be planned in any geo-referenced field map. The agronomist can choose from a large number of parameters (e.g. products, number of replicates, product use rates, etc.) for the test and adapt them to his needs. The main outcome will be the development and optimization of rules or algorithms for variable rate technologies leading to an increased efficiency of crop production systems as the product inputs/yield ratio can be optimized not only on field level but on spatial level. This spatial adaption of farming product inputs (in German: “teilflachenspezifischer Einsatz von Produktionsmitteln”) is a major factor to improve the sustainability of crop production systems around the world as yield can be maintained or even improved with less inputs of seed, fertilizers and crop protection chemicals, etc. In an example, a Trial Planning App is provided having different trial design options to compare treatments (two different products at one timing, same product at different application times but as well the same product applied in an on/off or rate variation system based on thresholds) for their yields, efficacy level and/or plant health indices.

The computer program element might be stored on a computer unit, which might also be part of an embodiment. This computing unit may be configured to perform or induce performing of the steps of the methods described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the invention covers both, a computer program that right from the beginning uses the invention and computer program that by means of an update turns an existing program into a program that uses invention. Further on, the computer program element might be able to provide all necessary steps to fulfill the procedure of an exemplary embodiment of the methods as described above. According to a further exemplary embodiment of the present invention, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

### BRIEF DESCRIPTION OF THE DRAWINGS

In the following, the invention is described exemplarily with reference to the enclosed figure, in which

FIG. 1 is a schematic overview of a method for providing test design and test instruction data for comparative tests for yield and/or gross margin, efficacy and/or effects on certain vegetation indices on a field for two or more products according to the preferred embodiment of the present invention;

FIG. 2 is a schematic view of the biomass distribution of a field;

FIG. 3 is a schematic view of a plot design for the field shown in FIG. 2;

FIG. 4 is a schematic view of the provided sampling locations for the plot design of the field shown in FIG. 2;

FIG. 5 is a schematic view of a strip design for the field shown in FIG. 2; and

FIG. 6 is a schematic view of the provided sampling locations for the strip design of the field shown in FIG. 2.

### DETAILED DESCRIPTION OF EMBODIMENT

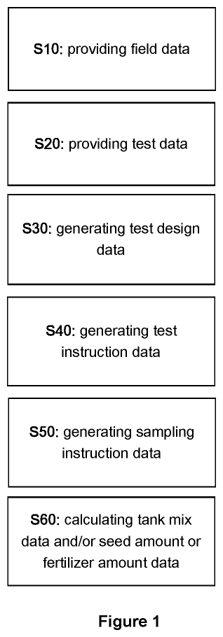

FIG. 1 is a schematic overview of a method for providing test design and test instruction data for comparative tests for yield and/or gross margin, efficacy and/or effects on certain vegetation indices on a field for at least two products according to the preferred embodiment of the present invention. In the following, an exemplary order of the steps according to the preferred embodiment of the present invention is explained.

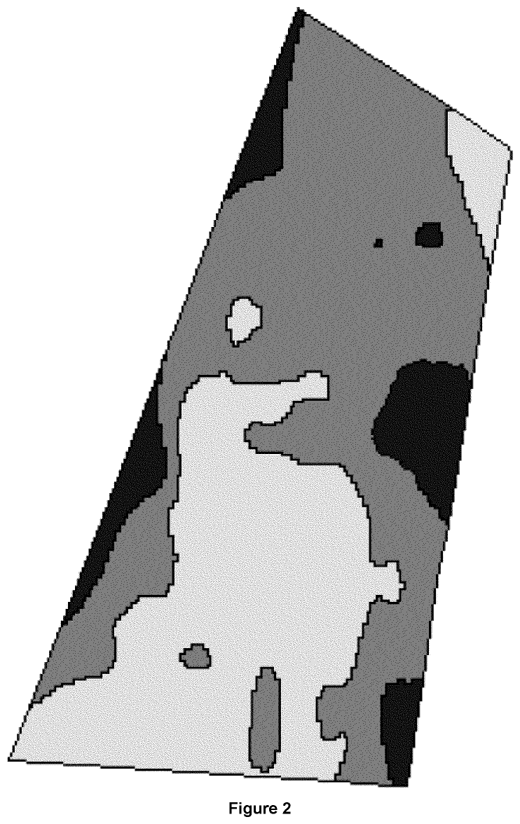

In a step S10, “field data” are provided. The field data comprises at least the biomass distribution and the geographical information of a field, as shown in FIG. 2. The field data can be provided, for example, as so called shape file and field metadata, of the field. In this respect, it is preferred that the “field data” further comprises electrical conductivity data, soil type data, soil texture data and/or topography data and wherein when generating the test instruction data at least two plots and/or strips are specified having comparable biomass data and preferably comparable electrical conductivity, soil type, soil texture and/or topography.

The biomass distribution data are preferably based on Normalized Difference Vegetation Index (N DVI) Data and/or Leaf Area Index (LAI) Data and/or any other vegetation based indices data. In this respect, it is further preferred that the biomass distribution data is obtained by using Synthetic Aperture Radar (SAR), Light Detection and Ranging (LIDAR), satellite, unmanned vehicles or vehicle mounted sensors.

Preferably, the biomass data is based on current data obtained preferably within a time frame of one or two weeks prior to the start of the respective comparative tests and/or historical data obtained over a period of time, preferably over a period of more than 5 or 10 years showing the mid to long term productivity zones of a field across crop rotations. The biomass data preferably comprises information in form of biomass zone categories, preferably indicating whether the biomass in a zone is above-average, average or below average, wherein it is preferred that the biomass data is provided in 3, 5 and/or 7 categories.

In a step 20, “test data” are provided. The test data comprises at least product use rate data about the at least two products to be compared, e.g. constant product use rates of said products, and/or variable product use rates of said products, and/or different application timings of said products whose effect (e.g. on yield) are to be compared by the comparative test. In this respect, the “test data” may further comprise repetition data comprising information about the intended treatment repetitions of said products and wherein when generating the test instruction data application time data corresponding to the treatment repetitions is assigned to the specified plots and/or strips. Moreover, plot and/or a strip dimensions are preferably provided as basis for generating the test design data. Test data can, for example, be provided manually by an agronomist using corresponding input devices, such as the keyboard and mouse of a computer unit, and/or as a predefined standard test pattern. For example, the agronomist can be provided with a standard test pattern that he can adapt to his own needs. In this context, the agronomist can also be offered access to different databases from which he can select said products to be tested and from which he can take the standard use rates specified by the manufacturer. In this respect, it is further preferred that the method further comprises the step of generating the product use rates and/or variable product use rates based on the biomass distribution data. The product use rates of the products to be compared can, for example, be adjusted as a function of the biomass distribution to be found in a field. Thereby, the product use rates proposed by the manufacturer can be adjusted to the biomass value of the strips/plots in which the products to be compared are applied. This adjustment is based on the finding that for increasing the yield in a specific field, a higher product use rate should be used with higher biomass and a lower product use rate should be used with lower biomass.

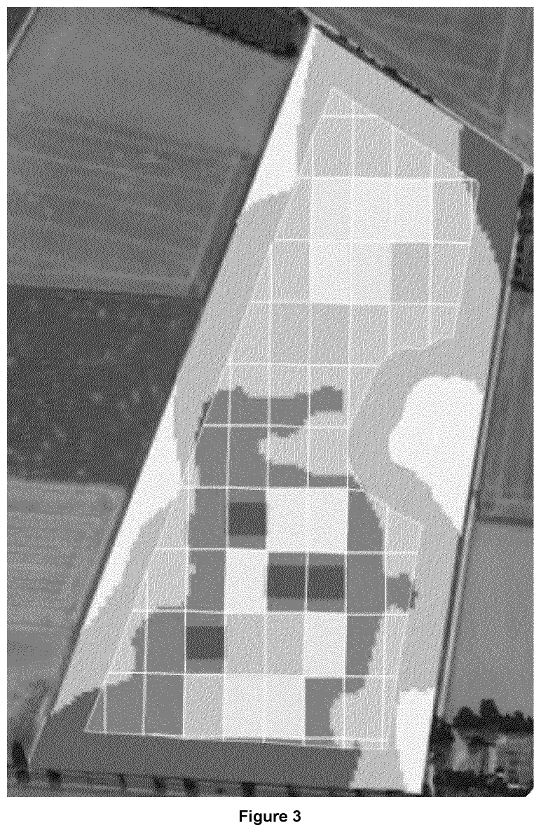

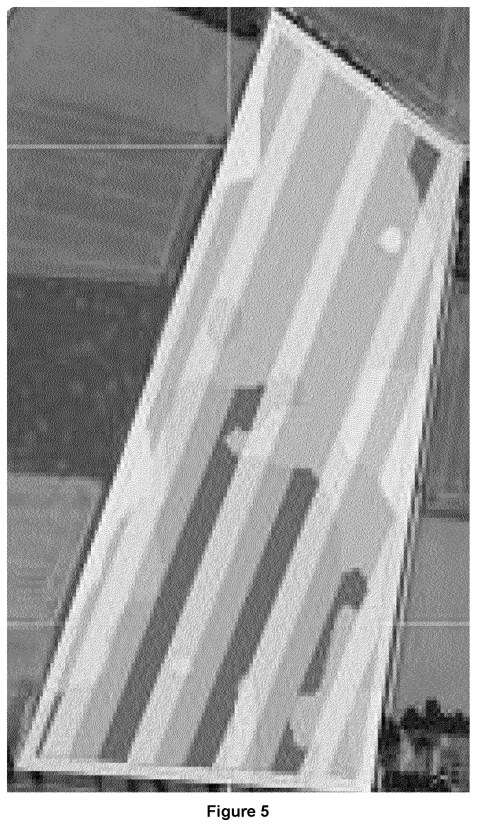

In a step 30, the “test design data” are generated, i.e. the field is segmented into “plots” as shown in FIG. 3 and/or in “strips” as shown in FIG. 5. In this context it should be noted that the segmentation of the field into plots and/or strips is automated or partially automated and does not depend on the biomass distribution, i.e. the determination of comparable plots and/or strips only takes place in a subsequent step when the plots and/or strips have been generated. By means of the present invention, a farmer may choose between a plot and/or a strip design. A strip design can be more easily implemented by farmers even without too sophisticated equipment, wherein a plot design make better use of the given field area and multiple different plots may be provided having comparable biomass values. The plots and/or strips are provided/calculated based on the field boundaries, which are provided by means of the field data. Subsequently, a tramline entry point and a tramline degree can be chosen, usually based on the longest natural axis of the field, i.e. the tramline direction. Then, a strip design/pattern can be placed over the field based on the tramline entry point and the tramline direction, wherein the strip width is either preset or entered manually by a farmer as part of the test data. For the plot design, the strips are further divided, usually in regular plots. The tramline entry point is a point within the field, where the tramline (working line, driving lane) of the field equipment is identify. This should coincide with the center of the application machinery, such as the center of gravity point of an agricultural machine, e.g. a seeder, sprayer, etc. Notably, whether or not this marks the top, center or bottom in driving direction is not immensely important, since the full-field is traced out. The tramline enter degree is the driving orientation of the agricultural machine through the field. In practice, this typically coincides with the longest natural straight direction within the field. This provided strip or plot design can be reused and the exact same positions can be used at different times for different tests.

In a step 40, “test instruction data” are generated allocating the respective application quantity to “plots” and/or “strips” with a comparable biomass value, i.e. assigning the products, their use rates and/or their application timings to these at least two plots and/or at least two strips. In other words a first product is assign to a first plot/strip and a second product is assigned to a second plot/strip, wherein both plots/strips have comparable biomass values. In this context, it should be noted that comparable biomass values are not limited to identical biomass values, as such an identity of biomass values will be comparatively rare in practice. The term comparable biomass values therefore refers to biomass values for which it is not to be expected that their difference will lead to a noticeable change in the test results, i.e. comparable biomass values are present if more or less identical results can be expected on two plots and/or strips under identical handling. Preferably, the test instruction data is generated by specifying different groups of plots and/or different groups of strips having comparable biomass data and assigning different product use rates and/or application timing to these groups of plots and/or groups of strips. It is further preferred that the product is a seed product, a fertilizers product and/or a crop protection product.

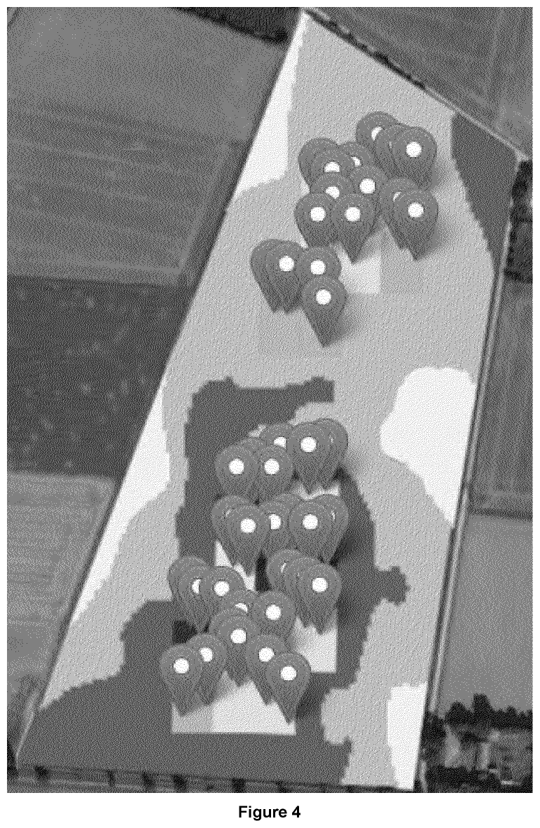

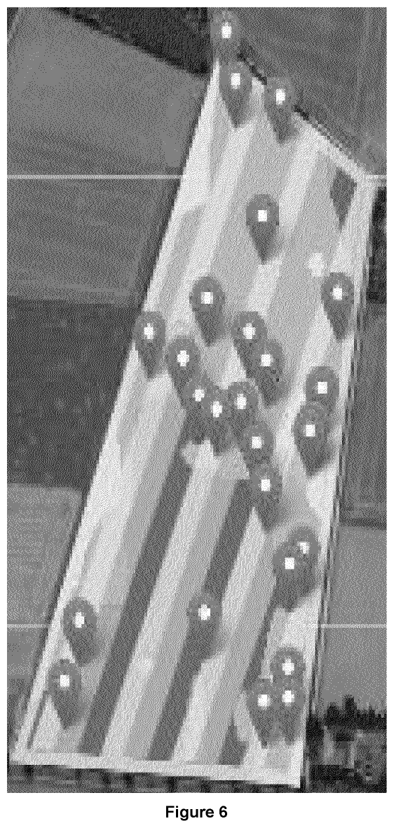

It is preferred that the method further comprises a step S50 generating “sampling instruction data” comprising information about sampling locations, as shown in FIGS. 4 and 6, and/or sampling periods for taking samples or performing measurements in a respective plot and/or strip, wherein the locations are preferably provided in form of geographic coordinates. In this respect, it is further preferred that the sampling locations are automatically placed away from the border of adjacent plots/strips and from tractor tramlines to avoid bordering effects. Moreover, in this respect, it is further preferred that the sampling locations are generated distanced from the border of adjacent plots/strips and from tractor tramlines, wherein the distance is between 2.5% and 20% of the plot/strip width and/or length, preferably 5% of the plot/strip width and/or length.

The method further preferably comprises the step of calculating tank mix data and/or seed amount or fertilizer amount data S60 based on the generated test instruction data and the geographic data, wherein the tank mix is preferably calculated with a product buffer of less than 5% and most preferably with a product buffer of less than 2.5%. The aim of the tank mix calculation is to achieve a tank filling with which no or almost no tank mix remains in the tank after application, since such a mix is often diluted and destroyed by the farmer.

The present invention has been described in conjunction with a preferred embodiment as examples as well. However, other variations can be understood and effected by those persons skilled in the art and practicing the claimed invention, from the studies of the drawings, this disclosure and the claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer implemented method for providing test design and test instruction data for comparative tests for yield and/or gross margin, efficacy and/or effects on certain vegetation indices on a field for at least a first product and a second product having a similar area of use, the method comprising:
providing field data (S10) comprising at least biomass distribution data and geographic data about the field on which the comparative tests are to be performed;
providing test data (S20) product use rate data about constant product use rates of said first product and said second product, and/or variable product use rates of said first product and said second products, and/or application timings of said first product and said second products whose effect are to be compared by the comparative tests for yield and/or gross margin, efficacy and/or effects on certain vegetation indices;
generating test design data (S30) based on the provided geographic data by segmenting the field in plots and/or strips; and
generating test instruction data (S40) by specifying at least two plots and/or at least two strips having comparable biomass data and assigning use rates and/or application timings of said products to the at least two plots and/or at least two strips having a comparable biomass data.

2. The method according to claim 1, further comprising:
providing a product database in which at least information about products having a similar area of use are included;
performing a database search in the product database determining a first product and a second product based on information about the area of use and/or determining a second product having a similar area of use in view of a specified first product; and
providing first product data and second product data as test data.

3. The method according to claim 2, wherein the product database comprises information about use rates of the products provided by the manufacturer; and the method further comprises:
performing a database search in the product database determining a product use rate of said first product and/or a product use rate of said second product;
providing product use rate data for said first product and/or product use rate data for said second product; and
providing use rate data for said first product and/or use rate data for said second product as test data.

4. The method according to claim 1, further comprising generating constant product use rates and/or different variable product use rates for said first product and/or said second product based on the biomass distribution data.

5. The method according to claim 1, wherein the test instruction data is generated by specifying different groups of plots and/or different groups of strips having comparable actual absolute LAI biomass or multiyear absolute LAI biomass data and assigning use rates and/or application timings of said products to the these groups of plots and/or groups of strips having a comparable biomass data.

6. The method according to claim 1, wherein the product is a seed product, a fertilizers product and/or a crop protection product.

7. The method according to claim 1, wherein the biomass distribution data is based on the absolute LAI-based actual biomass data, Normalized Difference Vegetation Index (NDVI) Data and/or actual or multiyear Leaf Area Index (LAI) Data and/or any other vegetation based indices data, wherein the biomass distribution data is obtained by using Synthetic Aperture Radar (SAR), Light Detection and Ranging (LIDAR) via satellites, unmanned vehicles or vehicle mounted sensors.

8. The method according to claim 1, wherein the biomass data is based on current data obtained within a time frame of two weeks prior to the start of the comparative tests and/or historical data obtained over a period of time showing the mid to long term productivity zones of a field.

9. The method according to claim 1, wherein the biomass data comprises information in form of biomass zone categories, indicating whether the biomass in a zone is above-average, average or below average, wherein the biomass data is provided in 3, 5 and/or 7 categories.

10. The method according to claim 1, wherein the field data further comprises electrical conductivity data, soil type data, soil texture data, topography data, organic matter data, nitrogen content data, potassium content data and/or pH value data and wherein when generating the test instruction data at least two plots and/or strips are specified having the comparable biomass data and electrical conductivity data, soil type data, soil texture data, topography data, organic matter data, nitrogen content data, potassium content data and/or pH value data; and/or when generating the test instruction data different data are weighted differently such that the biomass data is weighted with 50%, the electric conductivity data and topography data are weighted with 25% each.

11. The method according to claim 1, wherein the test data further comprise repetition data comprising information about the intended treatment repetitions with said products and wherein when generating the test instruction data application time data corresponding to the treatment repetitions are assigned to the specified plots and/or strips.

12. The method according to claim 1, wherein the method further comprises the step of generating sampling instruction data (S50) comprising information about sampling locations and/or sampling periods for taking samples or performing measurements in a respective plot and/or strip, wherein the locations are provided in form of geographic coordinates, wherein the sampling locations are automatically placed away from the border of adjacent plots/strips and from tractor tramlines to avoid bordering effects, wherein the sampling locations are generated distanced from the border of adjacent plots/strips and from tractor tramlines, wherein the distance is between 2.5% and 20% of the plot/strip width and/or length.

13. The method according to claim 1, further comprising the step of calculating tank mix data and/or seed amount or fertilizer amount based on the generated test instruction data and the geographic data, wherein the tank mix is calculated with a product buffer of less than 5%.

14. Use of field data comprising at least biomass data in a method for providing test design and test instruction data for comparative tests for yield and/or gross margin, efficacy and/or effects on certain vegetation indices on a field for products according to the method of claim 1, wherein based on the biomass data test instruction data is generated.

15. Use of a method for providing test design and test instruction data for comparative tests for yield and/or gross margin, efficacy and/or effects on certain vegetation indices on a field for products according to the method of claim 1 for performing a comparative tests for yield and/or gross margin, efficacy and/or effects on certain vegetation indices and for providing comparative test result data, e.g. yield test result data; and wherein the comparative test result data is used in a plant growth simulation and/or in a disease simulation model; and wherein the comparative test result data is used for calculating product use rate data for “Variable Rate Applications” (VRA) and/or “Variable Rate Seeding” (VRS) and/or Multiple Rate Variation (MRV).

16. A system for providing test design and test instruction data for comparative tests on a field for at least a first product and a second product, the system comprising:
at least one data input interface configured to receive field data comprising at least biomass data and geographic data about the field on which the comparative tests are to be performed;
at least one data input interface configured to receive/capture test data comprising product use rate data about constant product use rates of said first product and said second product, and/or variable product use rates of said first product and said second products, and/or application timings of said first product and said second products whose effect, e.g. on yield, are to be compared by the comparative tests;
at least one processing unit configured to generate test design data based on the provided geographic data by segmenting the field in plots and/or strips; and
at least one processing unit configured to generate test instruction data by specifying at least two plots and/or at least two strips having comparable biomass data and assigning use rates and/or application timings of said products to the at least two plots and/or at least two strips having a comparable biomass data.

17. A non-transitory computer-readable medium having instructions encoded thereon that, when executed by a processor, cause the processor to carry out the method according to claim 1.
